(19) United States
(12) Patent Application Publication
(10) Pub. No.: US 2007/0237688 A1
(43) Pub. Date: Oct. 11, 2007

(54) Fragrance oil dispenser

(76) Inventor: Andrew Walker, St. Louis, MO (US)

Correspondence Address: Andrew Walker, 410 Carson Rd., St. Louis, MO, 63135, US

(21) Appl. No.: 11/399,699

(22) Filed: Apr. 7, 2006

(51) Int. Cl. A62B 7/08

(52) U.S. Cl. 422/125

(57) ABSTRACT

A fragrance oil dispenser for easily and efficiently dispensing fragrance oil to the atmosphere includes a hollow bottle having an aesthetically distinct and pleasing appearance. The bottle includes a hollow base portion with a candle received therein; a neck portion extends from the base portion. A fragrance oil dispensing tube is mounted on the top end of the neck. Fragrance oil received within the dispensing tube is heated by the candle whereby it vaporizes and is dispersed to the atmosphere via openings on the top end of the dispensing tube. A safety carrying handle that starts from the base portion of the bottle and extends upwards to the top of the bottle for carrying.

### BACKGROUND OF THE INVENTION

The present invention relates to a device that easily and efficiently disperses fragrance oil to the atmosphere.

### DESCRIPTION OF THE PRIOR ART

A myriad of air freshening devices exist in the prior art such as scented candles, aerosol fresheners and various devices for heating and dispensing fragrance oil. However, many of these items can be unsightly and/or inefficient. The present invention addresses this problem by providing an aesthetically pleasing device that efficiently heats and disperses fragrance oil to the atmosphere.

### SUMMARY OF THE INVENTION

The present invention relates to a fragrance oil dispensing device comprising a hollow, aesthetically enhanced bottle having a wide profile base portion with a narrow, elongated neck extending therefrom. The base portion anchors the bottle in an upright position. The neck portion includes an open top end with a rim formed thereabout. A mating collar is superimposed on the rim and includes a centrally disposed aperture. Received within the aperture is a fragrance oil tube including a lower section and an upper section. The lower section includes a nipple that tightly fits within the aperture on the collar allowing the tube to be uprightly supported thereon. The upper and lower sections are removably joined with threaded fasteners or similar means. The upper section includes a plurality of dispensing apertures through which fragrance oil is emitted. A candle is received within the base portion of the bottle. When the candle is lit, heat from the flame traverses the elongated neck to the fragrance oil tube thereby vaporizing and dispersing the fragrance oil through the dispensing apertures.

Also for added protection when carrying the device it has a safety carrying handle for the intended user.

It is another object of the present invention to provide a fragrance oil dispenser that is aesthetically pleasing.

It is yet another object of the present invention to provide a fragrance oil dispenser that easily and efficiently disperses fragrance oil to the atmosphere.

Other objects, features, and advantages of the present invention will become readily apparent from the following detailed description of the preferred embodiment when considered with the attached drawings and the appended claims.

### BRIEF DESCRIPTION OF THE DRAWINGS

FIG. 1 is a perspective view of the fragrance oil dispenser.

FIG. 2 is an exploded view of the fragrance oil dispensing tube.

FIG. 3 depicts the base portion of the bottle.

FIG. 4 is a detailed view of the rim and collar mechanism for retaining the fragrance oil tube and the safety carrying handle.

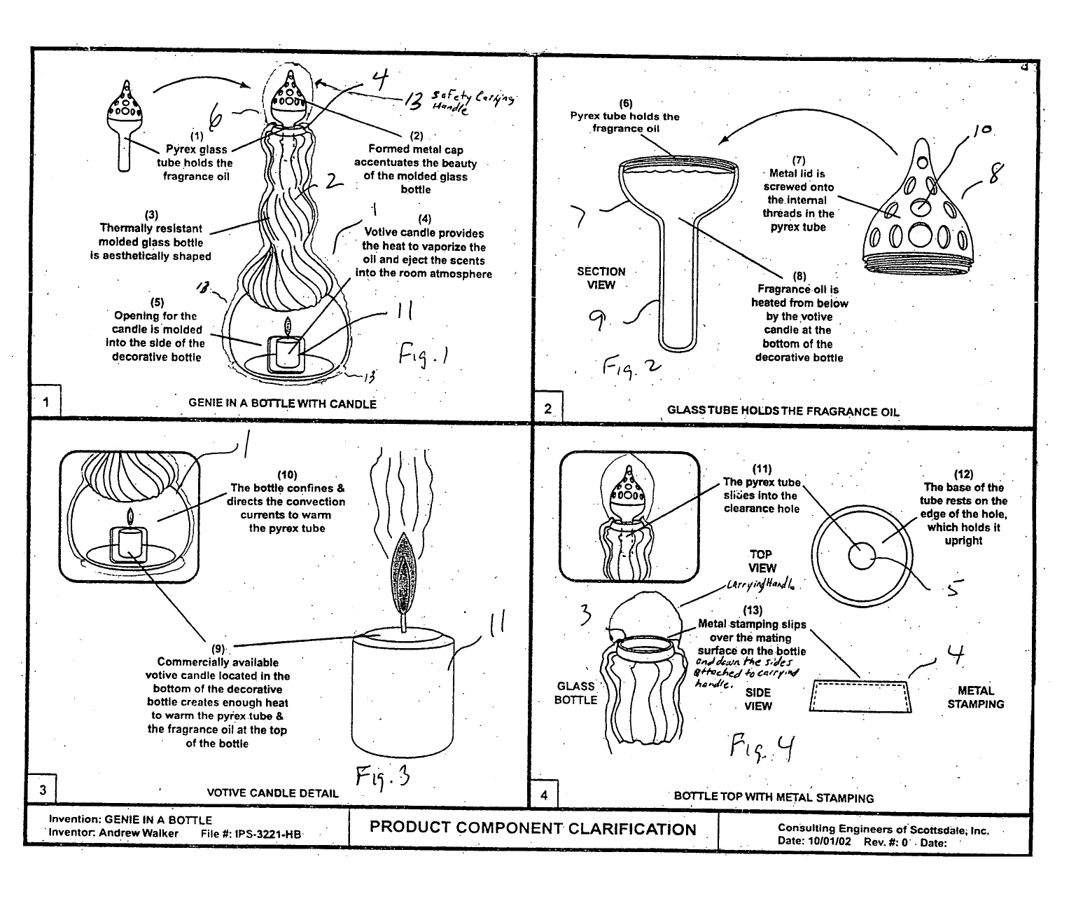

### DESCRIPTION OF THE PREFERRED EMBODIMENT

The present invention relates to a fragrance oil dispensing device comprising a hollow, aesthetically shaped bottle having a wide profile base portion with a narrow, elongated neck 2 extending therefrom. The base portion anchors the bottle in an upright position. The neck portion includes an open top end with a rim 3 positioned thereon. A mating collar 4 is superimposed on the rim and includes a centrally disposed aperture 5. Received within the aperture is a fragrance oil tube 6 including a lower section 7 and an upper section 8. The lower section includes an elongated nipple 9 that tightly fits within the aperture on the collar allowing the tube to be uprightly supported thereon. The upper and lower sections are removably joined with threaded fasteners or similar means.

The upper section includes a plurality of dispensing apertures 10 through which fragrance oil is emitted. A candle 11 is received within the base portion of the bottle. When the candle is lit, heat generated by the flame traverses the elongated neck to the fragrance oil tube thereby vaporizing and dispersing the fragrance oil through the dispensing apertures.

A safety carrying handle 13 is on the outer base portion of the bottle that extends upwards to the top of the bottle.

The above described device is not limited to the exact details of construction and enumeration of parts detailed above. Furthermore, the size, shape and materials of construction of the various components can be varied.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A fragrance oil dispenser device comprising:
(a) a hollow, aesthetically enhanced bottle having a wide profile base portion with a narrow, elongated neck extending there from.
(b) a base portion anchors the bottle in an upright position.
(c) a neck portion includes an open top end with a rim formed thereabout.

2. A fragrance oil dispenser system comprising a fragrance oil dispenser as defined in claim 1, and a mating collar is superimposed on the rim and includes a centrally disposed aperture and carrying handle.

3. A fragrance oil dispenser system comprising a fragrance oil dispenser as defined in claim 1, received within the aperture is a fragrance oil tube including a lower section and an upper section.
(a) the lower section includes a nipple that fits within the aperture on the collar allowing the tube to be uprightly supported thereon.
(b) the upper and lower sections are removable joined with threaded or similar means.

4. A fragrance oil dispenser system comprising a fragrance oil dispenser as defined in claim 1, with the upper section includes a plurality of dispensing apertures through which fragrance oil is emitted.

5. A fragrance oil dispenser system comprising a fragrance oil dispenser as defined in claim 1, and a candle is received within the base portion of the bottle.
(a) when the candle is lit, heat from the flame traverses the elongated neck to the fragrance oil tube thereby vaporizing and dispersing the fragrance oil through the dispensing apertures.

6. A fragrance oil dispenser system comprising a fragrance oil dispenser as defined in claim 1, received around the rim is a safety carrying handle including a lower section and an upper section.
(a) the lower section includes a metal base in which the bottle cradles itself into.
(b) the upper sections is the carrying handle that is attached by the two metal strips on the side of the bottle.
